(19) United States
(12) Patent Application Publication
(10) Pub. No.: US 2026/0149990 A1
(43) Pub. Date: May 28, 2026

(54) ADAPTING QUALITY OF EXPERIENCE (QoE) MEASUREMENT REPORT SIZES

(71) Applicant: Lenovo (United States) Inc., Morrisville, NC (US)

(72) Inventor: Hyung-Nam CHOI, Ottobrunn (DE)

(21) Appl. No.: 18/957,139

(22) Filed: Nov. 22, 2024

(51) Int. Cl. H04W 24/10; H04L 65/1016; H04W 76/27

(52) U.S. Cl. CPC H04W 24/10; H04L 65/1016; H04W 76/27

(57) ABSTRACT

Various aspects of the present disclosure relate to methods and systems for configuring a user equipment (UE) to perform quality of experience (QoE) measurement procedures, such as message segmentation, based on capabilities of the UE and/or an associated network node (e.g., a base station). For example, the UE may be configured to adapt or modify a size of a generated QoE measurement report for a network service based on support of message segmentation (e.g., uplink radio resource control (RRC) segmentation) by the UE and/or the network node.

### TECHNICAL FIELD

The present disclosure relates to wireless communications, and more specifically to adapting quality of experience (QoE) measurement report sizes.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A QoE measurement collection (QMC) functionality facilitates an operator of a wireless communications system to collect and utilize QoE measurements, performed by UEs, for various services supported by the wireless communications system, such as streaming services, Multimedia Telephony Service for IP Multimedia System (MTSI) services, extended reality (XR) services, gaming, and so on. The operator may utilize the QoE measurements when configuring (e.g., optimizing) and/or enhancing a network for the supported services.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that configure and/or adapt QoE measurement reports.

A UE for wireless communication is described. The UE may be configured to, capable of, or operable to perform one or more operations as described herein. For example, the UE may comprise at least one memory and at least one processor coupled with the at least one memory and configured to cause the UE to receive a first message comprising a configuration that indicates a set of one or more parameters associated with collection and reporting of QoE measurements for a network service, perform the QoE measurements for the network service based on the set of one or more parameters, and transmit a second message that comprises the QoE measurements for the network service.

A processor for wireless communication is described. The processor may be configured to, capable of, or operable to perform one or more operations as described herein. For example, the processor may comprise at least one controller coupled with at least one memory and configured to cause the processor to receive a first message comprising a configuration that indicates a set of one or more parameters associated with collection and reporting of QoE measurements for a network service, perform the QoE measurements for the network service based on the set of one or more parameters, and transmit a second message that comprises the QoE measurements for the network service.

A method performed or performable by a UE is described. The method may comprise receiving a first message comprising a configuration that indicates a set of one or more parameters associated with collection and reporting of QoE measurements for a network service, performing the QoE measurements for the network service based on the set of one or more parameters, and transmitting a second message that comprises the QoE measurements for the network service.

In some implementations of the UE, processor, and method described herein, the set of one or more parameters includes a time interval for collection of the QoE measurements, a maximum size of a QoE measurement report that includes the QoE measurements, a maximum number of segments of the second message, or a combination thereof.

In some implementations of the UE, processor, and method described herein, the set of one or more parameters includes a segment parameter associated with a capability of the UE to transmit the second message via multiple segments.

In some implementations of the UE, processor, and method described herein, the segment parameter identifies a maximum number of segments for the second message.

In some implementations of the UE, processor, and method described herein, the UE, processor, and method may further be configured to, capable of, performable, or operable to perform, via an application layer of the UE, the QoE measurements for the network service and generate a QoE measurement report container that includes a single QoE measurement report based the one or more parameters, and generate, via an access stratum (AS) layer of the UE, the second message as multiple segments based on the QoE measurement report container and the one or more parameters and transmit the multiple segments to a network entity.

In some implementations of the UE, processor, and method described herein, the one or more parameters include a parameter associated with a maximum number of uplink radio resource control (RRC) segments for the second message.

In some implementations of the UE, processor, and method described herein, the UE is in an RRC_IDLE state, and the UE, processor, and method may further be configured to, capable of, performable, or operable to receive the first message for a multicast broadcast service (MBS), and store a QoE measurement report that includes the performed QoE measurements for the network service based in an AS layer buffer of the UE.

In some implementations of the UE, processor, and method described herein, the network service is a streaming service, a virtual reality service, or a multimedia telephony service for IP multimedia subsystem (IMS) (MTSI) service.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit, to a UE, a first message comprising a configuration that indicates a set of one or more parameters associated with collection and reporting of QoE measurements for a network service, and receive, from the UE, a second message that comprises the QoE measurements for the network service.

A method performed or performable by network entity is described. The method may comprise transmitting, to a UE, a first message comprising a configuration that indicates a set of one or more parameters associated with collection and reporting of QoE measurements for a network service, and receiving, from the UE, a second message that comprises the QoE measurements for the network service.

In some implementations of the network entity and method described herein, the set of one or more parameters includes a time interval for collection of the QoE measurements, a maximum size of a QoE measurement report that includes the QoE measurements, a maximum number of segments of the second message, or a combination thereof.

In some implementations of the UE, processor, and method described herein, the set of one or more parameters includes a segment parameter associated with a capability of the network entity to receive the second message via multiple segments.

In some implementations of the UE, processor, and method described herein, the segment parameter identifies a maximum number of segments for the second message.

In some implementations of the UE, processor, and method described herein, the segment parameter identifies a maximum number of uplink RRC segments for the second message.

In some implementations of the UE, processor, and method described herein, the set of one or more parameters includes a segment parameter associated with capabilities of one or more neighbor network entities to receive the second message via multiple segments.

In some implementations of the network entity and method described herein, the network entity and method may further be configured to, capable of, performable, or operable to transmit the first message for an MBS.

In some implementations of the network entity and method described herein, the network service is a streaming service, a virtual reality service, or an MTSI service.

### BRIEF DESCRIPTION OF THE DRAWINGS

FIG. 1 illustrates an example of a wireless communications system in accordance with aspects of the present disclosure.

FIG. 2 illustrates example communications between a base station and a UE in accordance with aspects of the present disclosure.

FIG. 3 illustrates an example diagram of a messaging flow that supports QoE measurement collection and reporting in accordance with aspects of the present disclosure.

FIG. 4 illustrates an example diagram of a segmented QoE measurement report.

FIG. 5 illustrates an example diagram of a messaging flow that supports QoE measurement collection and reporting in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by an NE in accordance with aspects of the present disclosure.

FIG. 10 illustrates a flowchart of a method performed by a UE in accordance with aspects of the present disclosure.

### DETAILED DESCRIPTION

A UE may be equipped (e.g., configured) with a protocol stack that includes multiple layers (also referred to as protocol layers), which may be organized logically (e.g., in a functional hierarchy rather than a physical arrangement), with higher layers (e.g., application layers) being above lower layers (e.g., physical layers), and each layer supporting various operations and signaling to enable services for the UE. Each layer may communicate directly or indirectly (e.g., output, input, transmit, receive, forward, etc.) with one or more other layers of the protocol stack. In some examples, for various network services, an application layer of the UE performs QoE measurements, such as measurements associated with a connectivity (e.g., download or upload speeds) provided by a network, latency, perceived quality (e.g., video quality), response times, and so on. The UE applies a QMC functionality when performing the QoE measurement collection and reporting. The QMC functionality may define various aspects of QoE measurement, such as messaging between devices (e.g., QoE measurement configurations and/or reports may be encapsulated in transparent containers), the generation of measurement configurations (e.g., via different network nodes), the segmentation of QoE measurement reports (e.g., messages that transmit the QoE measurement reports).

In some cases, a base station (e.g., a gNB) and/or a UE associated with QoE measurement collection and reporting may not support (e.g., be configured for, be capable of) the segmentation (e.g., uplink RRC segmentation) of messages or may support (e.g., be configured for, be capable of) a limited number of message segments. Further, QoE measurement reports may vary in size (e.g., kilobytes (kB)), based on the associated network service, the collected QoE metrics, reporting intervals, and so on. For example, for a service (e.g., XR or gaming), the collected QoE metrics may be reported after a long reporting interval (e.g., over 10 minutes), resulting in a large QoE report (e.g., 18 kB or larger). When the UE performing the QoE measurement collection and/or an associated base station does not support message segmentation, the UE cannot transmit a QoE measurement report that includes QoE metrics. The UE may discard the QoE measurement report, and the base station (e.g., via the gNB) does not receive relevant or useful QoE metrics for the supported network service. Further, the UE may waste resources when performing a QoE measurement collection that is ultimately discarded because the UE or the base station cannot perform message segmentation to facilitate transfer of the QoE measurement report to the network.

The present disclosure introduces a framework for configuring the UE to perform QoE measurement procedures, such as message segmentation, based on capabilities of the UE and/or a network node (e.g., a gNB). For example, the UE may be configured to adapt or modify a size of a generated QoE measurement report based on the support or capabilities of message segmentation (e.g., uplink RRC segmentation) by the UE and/or the network node. In doing so, the network node (via the UE) may enhance the collection and reporting of QoE measurements for certain network services, while avoiding issues that arise when QoE measurement reports are large and/or reported over long reporting intervals, among other benefits.

Aspects of the present disclosure are described in the context of a wireless communications system.

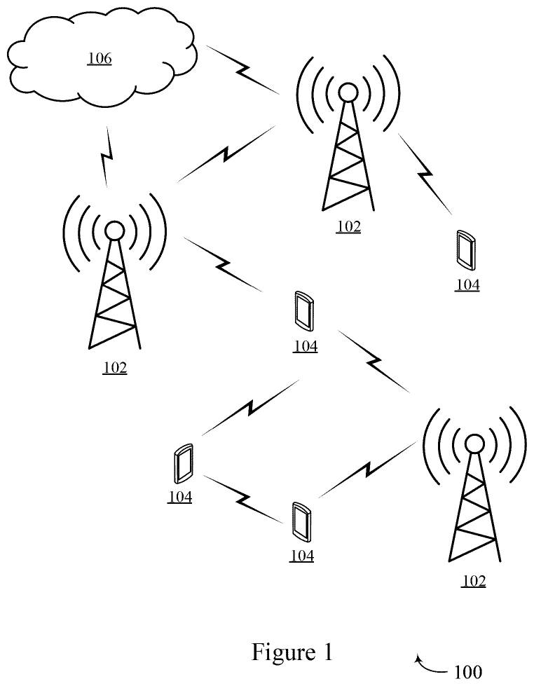

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other, or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

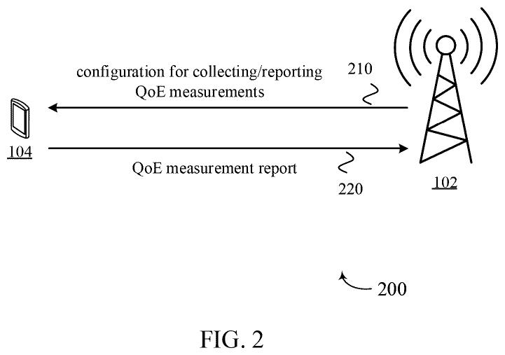

The wireless communications system 100 may support adapting sizes of QoE measurement reports, as described herein. FIG. 2 illustrates example communications between a base station and a UE in accordance with aspects of the present disclosure. A gNB or base station, such as the NE 102, transmits a message 210, which includes a QoE measurement configuration for collecting/reporting QoE measurements, to the UE 104.

For example, when the UE 104 supports the segmentation of a MeasurementReportAppLayer message (e.g., a message used to transmit a QoE measurement report), but only for a limited number of segments, the UE 104 may indicate a maximum number of uplink RRC segments (e.g., 2-15 segments) it supports to the NE 102 (e.g., the gNB). The UE 104 may send the indication via a UECapabilityInformation message. The NE 102 (e.g., the gNB) generates the QoE measurement configuration to adapt a reporting interval of a configured QoE measurement and/or select a maximum size of a QoE measurement report 220 generated by the UE 104.

The QoE measurement configuration may include one or more parameters, including a time interval or reporting interval for collection of QoE measurements, a maximum size of a QoE measurement report that includes the QoE measurements, a maximum number of segments of the QoE measurement report 220, and so on. For example, a “reporting interval” parameter may be in seconds or minutes, and a “maximum size of QoE report” may be in kBytes (e.g., 8 kBytes, 16, kBtyes, 24 kBytes, or other sizes based on an RRC message size limit of 9000 bytes). For example, the message 210 may include the maximum number of uplink RRC segments (e.g., 2-15 segments)

In some cases, when the NE 102 (e.g., the gNB) supports the segmentation of a MeasurementReportAppLayer message, but only for a limited number of segments, the NE 102 adapts the reporting interval of the configured QoE measurement report 220 and/or configures the maximum size of the generated QoE measurement report 220 based on its supported capabilities. For example, the NE 102 may transmit the message 210 to include, via the QoE measurement configuration, the maximum number of uplink RRC segments (e.g., 2-15 segments) supported by the gNB.

In some cases, when both the UE 104 and the NE 102 (e.g., the gNB) support the segmentation of a MeasurementReportAppLayer message, but only for a limited number of segments, the NE 102 (e.g., the gNB) may select a minimum value shared by both entities when configuring the parameters of the QoE measurement configuration. For example, if the UE 104 supports a maximum number of four RRC segments and the NE 102 (e.g., the gNB) supports a maximum number of eight RRC segments, the gNB may select a “reporting interval” value that facilitates the use of four segments when transmitting the QoE measurement report 220.

The UE 104 receives the message 210, which contains the QoE measurement configuration (e.g., a set of one or more parameters associated with collection and reporting QoE measurements for a network service. For example, as described herein, an access stratum layer of the UE 104 may receive the parameters-“reporting interval” and/or “maximum size of QoE report” and forward the parameters to an application layer (e.g., via an attention (AT) command).

The UE 104 performs the QoE measurements for the network service. In some cases, such as when the UE 104 is configured for QoE measurement collection in an RRC_IDLE or RRC_INACTIVE state, the NE 102 (e.g., the gNB) configures the UE 104 with the “reporting interval” and/or “maximum size of QoE report” parameters that are based on a segmentation capability of neighboring gNBs. For example, the NE 102 (e.g., the gNB) may select a value for segmenting a message (e. g, a MeasurementReportAppLayer message) that corresponds to a minimum value for the segmentation capability across all neighboring gNBs or other base stations. Thus, the UE 104 may generate and transmit QoE measurement reports in an RRC_IDLE/RRC_INACTIVE state, even when the UE 104 moves to a new gNB or base station during a cell mobility procedure (e.g., during a cell selection/reselection procedure while in the RRC_IDLE/RRC_INACTIVE state). The NE 102 (e.g., the gNB) may communicate with neighboring gNB via an Xn interface, or another suitable interface.

The UE 104 may transmit a second message that comprises the QoE measurements for the network service (e.g. the QoE measurement report 220) to the NE 102 (e.g., the gNB), based on the parameters within the QoE measurement configuration. For example, the UE 104 may adapt a size of the generated QoE measurement report 220 based on uplink RRC segmentation capabilities of the UE 104 and the NE 102, among other benefits.

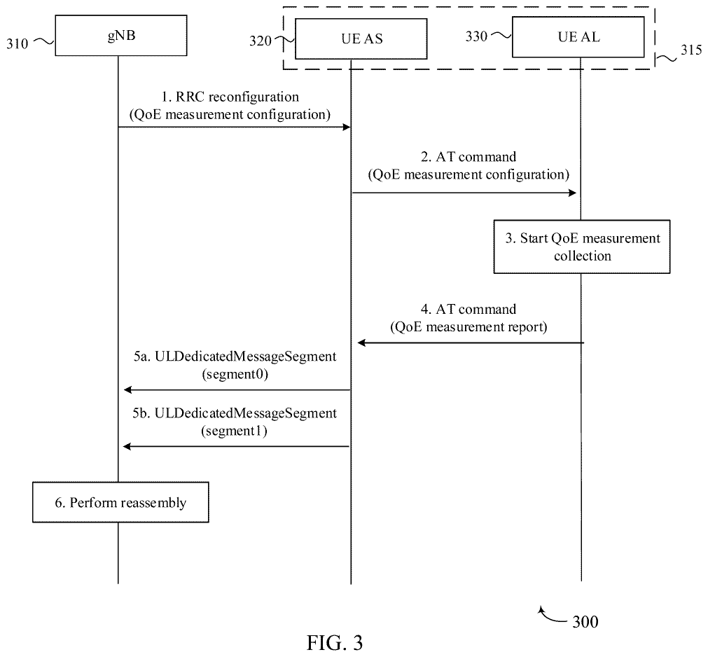

FIG. 3 illustrates an example diagram of a messaging flow 300 that supports QoE measurement collection and reporting in accordance with aspects of the present disclosure. The messaging flow 300 may implement various aspects of the present disclosure described herein. For example, the messaging flow 300 may include a gNB 310 (an example of the NE 102) and a UE 315 (having a UE AS 320, and a UE AL 330), which may be examples of NEs and UEs as described herein with reference to FIGS. 1 and 2.

In the following description of the messaging flow 300, the operations and/or signaling between the gNB 310, the UE 315, the UE AS 320, and the UE AL 330 may be performed or signaled (e.g., transmitted, received) in different orders or at different times than the example order or times shown. Some operations and/or signaling may also be omitted, or other operations or signaling may be added. Although the gNB 310, the UE 315, the UE AS 320, and the UE AL 330 are shown performing the operations of the messaging flow 300, some aspects of some operations may also be performed by other entities of the messaging flow 300 or by entities that are not shown in the messaging flow 300, or any combination thereof.

Before commencement of the message flow 300 (e.g., at step 0), the UE 315 may be within a cell that is served by the gNB 310 and operating in an RRC_CONNECTED state. For example, a protocol data unit (PDU) session for a virtual reality (VR) service, or another network service, may be established between the UE 315 and the gNB 310 (e.g., a serving gNB for the cell). The UE 315 supports QMC for the VR service and supports message segmentation (e.g., segmentation of a MeasurementReportAppLayer message) of 16 or fewer segments. Similarly, the gNB 310 supports QMC for the VR service and supports message segmentation (e.g., segmentation of a MeasurementReportAppLayer message) of two or fewer segments.

An Operations, Administration and Maintenance (OAM) function may request performance of QoE measurements for the VR service by the UE 315 and other UEs receiving network services via a Public Land Mobile Network (PLMN). The OAM may initiate the request via a QMC activation signaled to a CN (e.g., the CN 106) associated with the gNB 310. The CN 106 receives a QoE measurement configuration from the OAM, activates the QoE measurement configuration for the UE 315, and forwards the QoE measurement configuration to the gNB 310 using an “Activate QoE measurement” message.

For example, the QoE measurement configuration may include QoE metrics for the VR service, such as average throughput, initial playout delay, buffer level, play list, device information, and/or a reporting interval (e.g., set to 30 min), which corresponds to a time interval for collecting the QoE measurements.

Using the QoE measurement configuration received from the CN 106, the gNB 310 determines the UE 315 may generate QoE reports that exceed an RRC message size limit (e.g., 9000 bytes) and/or a maximum number of supported segments (e.g., a max of 2 segments).

At step 1, the gNB 310 may send an RRC reconfiguration message to the UE AS 320 of the UE 315. For example, the gNB 310 sends a QoE measurement configuration in an RRCReconfiguration message to the AS layer (e.g., the UE AS 320) of the UE 315. The QoE measurement configuration may include a QoE measurement configuration container and a set of one or more of the following parameters: a reporting interval set to 10 min, a maximum size of a QoE measurement report set to 16 kBytes, and/or a maximum number of allowed uplink RRC segments set to 2 segments.

In some embodiments, the UE 315 may support the segmentation of the MeasurementReportAppLayer message for a limited number of segments (e.g., 6 segments). The gNB 310 may select a minimum value of uplink RRC segmentation capabilities supported by the UE 315 and the gNB 310 when configuring the parameters (e.g., “reporting interval,” “maximum size of QoE report,” and/or “maximum number of allowed UL RRC segments”) in the QoE measurement configuration.

At step 2, the UE AS 320 sends an AT command to the UE AL 330. For example, the UE AS 320 sends the received QoE measurement configuration container and the set of one or more parameters (e.g., “reporting interval” and “maximum size of QoE report”) to UE AL 330 using the AT command.

At step 3, the UE AL 330 starts a QoE measurement collection. For example, the UE 315, vis the UE AL 330, collects or performs QoE measurements for the VR service based on the QoE measurement configuration. The UE AL 330 may apply the configured reporting interval (e.g., set to 10 min), received from the gNB 310, in place of a reporting interval (e.g., set to 30 min) defined in the QoE measurement configuration container.

At step 4, the UE AL 330 sends an AT command to the UE AS 320. For example, based on the received QoE measurement configuration, the UE AL 330 sends a first QoE measurement report (e.g., 16 kBytes in size) to the UE AS 320 in a QoE measurement report container using the AT command.

At steps 5a/5b, the UE 315, via the UE AS 320, transmits two message segments (e.g., ULDedicatedMessageSegment messages) to the gNB 310. For example, the UE AS 320 generates or creates a single MeasurementReportAppLayer message that contains the received first QoE measurement report. Based on the parameter “maximum number of allowed UL RRC segments” the UE AS 320 sends, to the gNB 310, the MeasurementReportAppLayer message in two segments, using ULDedicatedMessageSegment messages.

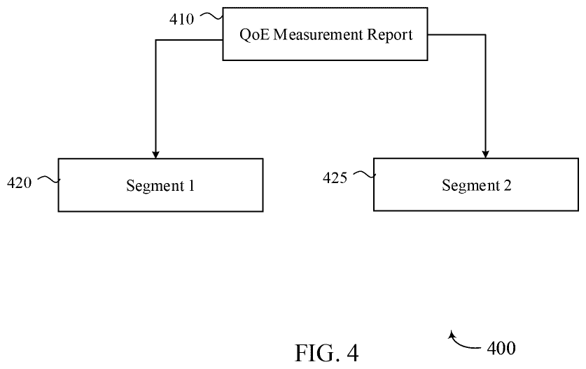

FIG. 4 illustrates an example diagram 400 of a segmented QoE measurement report. The UE AS 320, based on the parameters of the QoE measurement configuration, may segment or otherwise divide the QoE measurement report into two message segments 420, 430 (e.g., segment 1, segment 2). In some cases, the QoE measurement report may be divided into equal segments (e.g., each segment being 8 kBtyes). In other cases, the QoE measurement report may be divided into unequal segments (e.g., a first segment being 9 kBytes and a second segment being 7 kBytes). The UE AS 320 may transmit the two message segments 420, 430 using the ULDedicatedMessageSegment messages.

At step 6, the gNB 310 performs reassembly of the messages received from the UE AS 320. For example, the gNB 310 reassembles the received segments of the MeasurementReportAppLayer message and may forward the received QoE measurement report to a measurement collection entity (MCE) or similar entity (not shown) that is part of the CN 106 or outside of the CN 106.

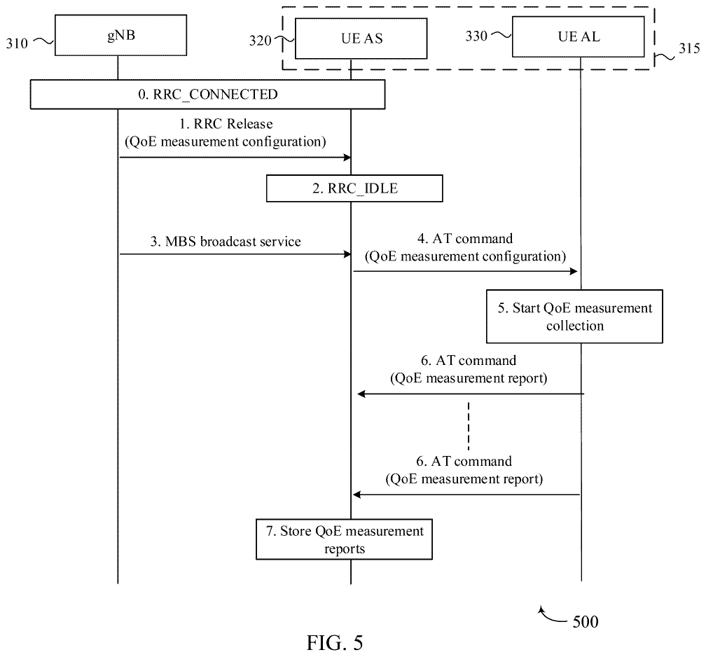

FIG. 5 illustrates an example diagram of a messaging flow 500 that supports QoE measurement collection and reporting in accordance with aspects of the present disclosure. The messaging flow 500 may implement various aspects of the present disclosure described herein. For example, the messaging flow 500 may include the gNB 310 (an example of the NE 102) and the UE 315 (having the UE AS 320, and the UE AL 330), which may be examples of NEs and UEs as described herein with reference to FIGS. 1 and 2.

In the following description of the messaging flow 500, the operations and/or signaling between the gNB 310, the UE 315, the UE AS 320, and the UE AL 330 may be performed or signaled (e.g., transmitted, received) in different orders or at different times than the example order or times shown. Some operations and/or signaling may also be omitted, or other operations or signaling may be added. Although the gNB 310, the UE 315, the UE AS 320, and the UE AL 330 are shown performing the operations of the messaging flow 500, some aspects of some operations may also be performed by other entities of the messaging flow 500 or by entities that are not shown in the messaging flow 300, or any combination thereof.

Before commencement of the message flow 500, the UE 315 may support QMC for an MBS broadcast service in an RRC_IDLE and an RRC_INACTIVE state. The UE 315 may support the segmentation of the MeasurementReportAppLayer message for a limited number of segments (e.g., 6 segments). Similarly, the gNB 310 may support QMC for the MBS broadcast service and the segmentation of the MeasurementReportAppLayer message for a limited number of segments (e.g., 2 segments).

The OAM may request performance of QoE measurements for the MBS broadcast service by the UE 315 and other UEs receiving network services via a Public Land Mobile Network (PLMN). The OAM may initiate the request via a QMC activation signaled to the CN 106. The CN 106 receives a QoE measurement configuration from the OAM, activates the QoE measurement configuration for the UE 315, and forwards the QoE measurement configuration to the gNB 310 using an “Activate QoE measurement” message.

For example, the QoE measurement configuration may include QoE metrics for the MBS broadcast service, such as average throughput, initial playout delay, buffer level, play list, device information, and/or a reporting interval (e.g., set to 30 min), which corresponds to a time interval for collecting the QoE measurements.

Using the QoE measurement configuration received from the CN 106, the gNB 310 determines the UE 315 may generate QoE reports that exceed an RRC message size limit (e.g., 9000 bytes) and/or a maximum number of supported segments (e.g., a max of 2 segments).

At step 0, the UE 315 is in an RRC_CONNECTED state. For example, a PDU session for voice communications has been established between the UE 315 and the gNB 310.

At step 1, the gNB 310 sends an RRC release message to the UE 315. For example, the gNB 310, in response to a voice call ending at the UE 315, sends an RRCRelease message to the UE AS 320 to transfer the UE 315 to an RRC_IDLE state. The RRCRelease message may contain a QoE measurement configuration for the MBS broadcast service in the RRC_IDLE state. As described herein, the QoE measurement configuration includes the QoE measurement configuration container and a set of one or more of the following parameters: a reporting interval (e.g., set to 10 min), a maximum size of the QoE report measurement (e.g., set to 16 kBytes), and/or a maximum number of allowed UL RRC segments (e.g., set to 2 segments).

At step 2, the UE 315 is in the RRC_IDLE state. For example, the UE 315 camps on a cell that is served by the gNB 310.

At step 3, the gNB 310 sends an MBS broadcast service message to the UE 315. For example, the UE 315 receives the MBS broadcast service message via the UE AS 320.

At step 4, the UE AS 320 sends an AT command to the UE AL 330. For example, the UE AS 320 sends the received QoE measurement configuration container and the set of one or more associated parameters (e.g., “reporting interval” and “maximum size of QoE report”) to the UE AL 330 using the AT command.

At step 5, the UE AL 330 starts QoE measurement collection. For example, the UE AL 330 starts or performs QoE measurement collection for MBS broadcast service based on the received QoE measurement configuration. The UE AL 330 may apply the configured reporting interval (e.g., set to 10 min), received from the gNB 310, in place of a reporting interval (e.g., set to 30 min) defined in the QoE measurement configuration container.

At step 6, the UE AL 330 sends one or more AT commands to the UE AS 320. For example, based on the received QoE measurement configuration, UE AL sends multiple QoE measurement reports to the UE AS 320 in a QoE measurement report container using the AT command. In some cases, each QoE measurement report has a size of 16 kBytes.

At step 7, the UE AS 320 stores the QoE measurement reports. For example, the UE AS 320 may temporarily store the QoE measurement reports from the UE AL 330 in a buffer of the UE AS 320 when the UE 315 is in the RRC_IDLE state.

In some cases, such as when the UE 315 returns to the RRC_CONNECTED state with a same serving gNB (e.g., the gNB 310), the UE 315 sends (not shown) the stored QoE measurement reports to the gNB 310 based on the parameter “maximum number of allowed UL RRC segments.” For example, the UE 315 sends the QoE measurement reports in multiple MeasurementReportAppLayer messages, where each MeasurementReportAppLayer message contains a single QoE measurement report and each MeasurementReportAppLayer message is sent in two segments to the gNB 310 using the ULDedicatedMessageSegment message. The gNB 310, as described with respect to FIG. 3, reassembles the received segments of each MeasurementReportAppLayer message and forwards the received QoE measurement reports to the MCE.

In some cases, such as when the UE 315 returns to the RRC_CONNECTED state with a different serving gNB (e.g., not the gNB 310), the UE 315 sends (not shown) the stored QoE measurement reports to the new or different gNB (as described herein), based on the parameter “maximum number of allowed UL RRC segments” applicable to the new or different gNB.

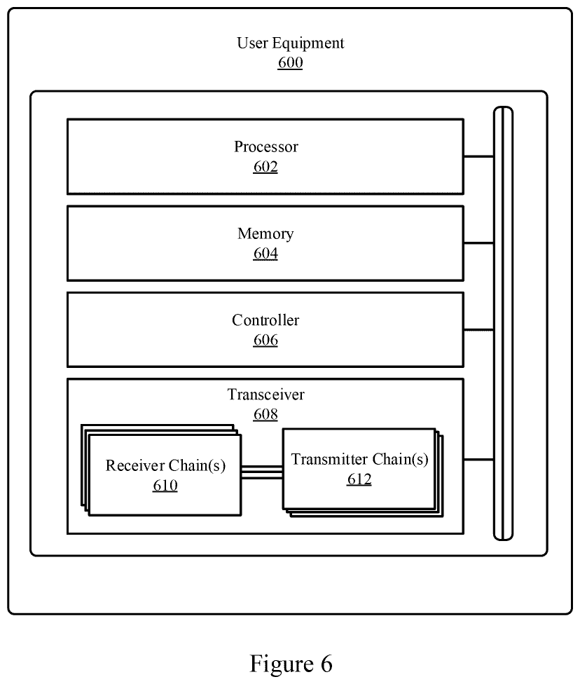

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604).

For example, the processor 602 may support wireless communication at the UE 600 in accordance with examples as disclosed herein. The UE 600 may be configured to support a means receiving a first message comprising a configuration that indicates a set of one or more parameters associated with collection and reporting of QoE measurements for a network service, performing the QoE measurements for the network service based on the set of one or more parameters, and transmitting a second message that comprises the QoE measurements for the network service.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

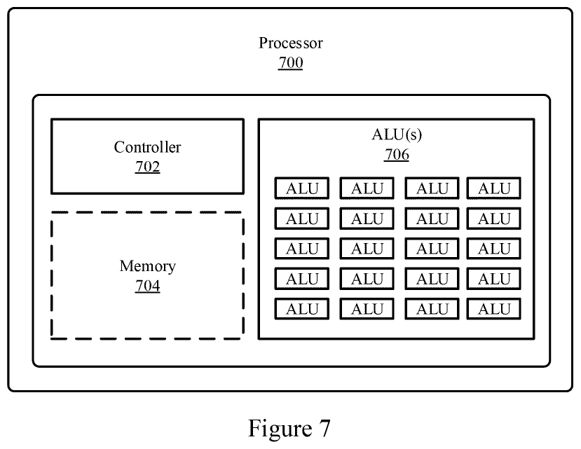

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to support a means for receiving a first message comprising a configuration that indicates a set of one or more parameters associated with collection and reporting of QoE measurements for a network service, performing the QoE measurements for the network service based on the set of one or more parameters, and transmitting a second message that comprises the QoE measurements for the network service.

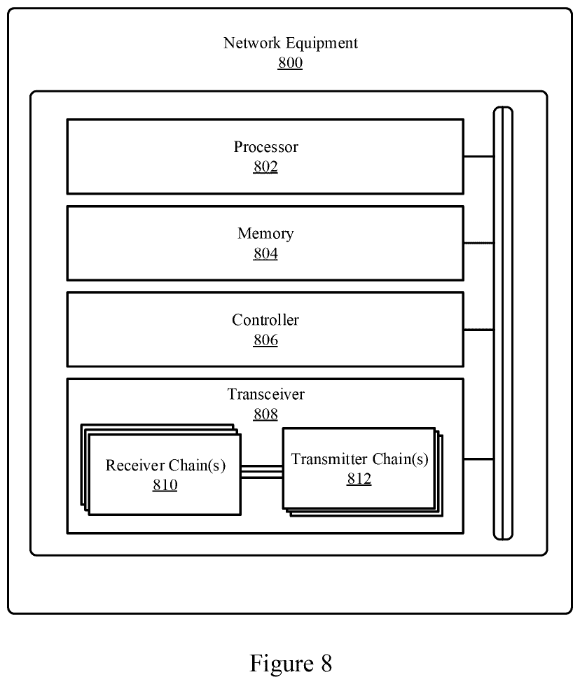

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804).

For example, the processor 802 may support wireless communication at the NE 800 in accordance with examples as disclosed herein. The NE 800 may be configured to support a means for transmitting, to a UE, a first message comprising a configuration that indicates a set of one or more parameters associated with collection and reporting of QoE measurements for a network service; and receiving, from the UE, a second message that comprises the QoE measurements for the network service.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

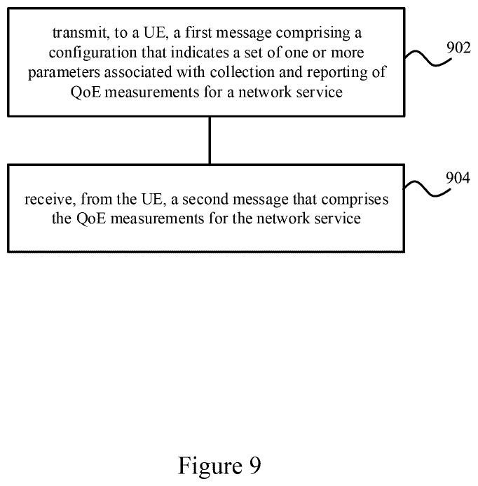

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include transmitting, to a UE, a first message comprising a configuration that indicates a set of one or more parameters associated with collection and reporting of QoE measurements for a network service. The operations of 902 may be performed in accordance with examples as described herein. In some implementations, aspects of the operations of 902 may be performed by an NE as described with reference to FIG. 8.

At 904, the method may include receiving, from the UE, a second message that comprises the QoE measurements for the network service. The operations of 904 may be performed in accordance with examples as described herein. In some implementations, aspects of the operations of 904 may be performed by an NE as described with reference to FIG. 8.

It should be noted that the method described herein describes a possible implementation, and that the operations and the steps may be rearranged or otherwise modified and that other implementations are possible.

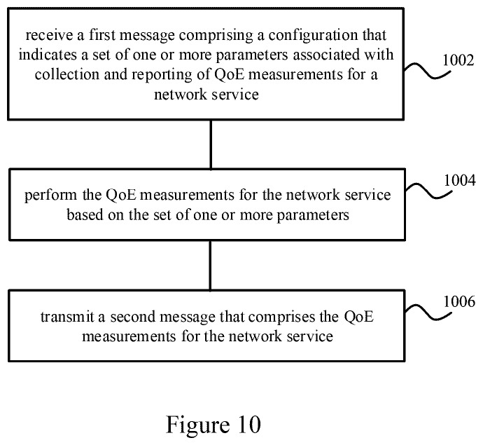

FIG. 10 illustrates a flowchart of a method in accordance with aspects of the present disclosure. The operations of the method may be implemented by a UE as described herein. In some implementations, the UE may execute a set of instructions to control the function elements of the UE to perform the described functions.

At 1002, the method may include receiving a first message comprising a configuration that indicates a set of one or more parameters associated with collection and reporting of QoE measurements for a network service. The operations of 1002 may be performed in accordance with examples as described herein. In some implementations, aspects of the operations of 1002 may be performed by a UE as described with reference to FIG. 6.

At 1004, the method may include performing the QoE measurements for the network service based on the set of one or more parameters. The operations of 1004 may be performed in accordance with examples as described herein. In some implementations, aspects of the operations of 1004 may be performed by a UE as described with reference to FIG. 6.

At 1006, the method may include transmitting a second message that comprises the QoE measurements for the network service. The operations of 1006 may be performed in accordance with examples as described herein. In some implementations, aspects of the operations of 1006 may be performed by a UE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first message comprising a configuration that indicates a set of one or more parameters associated with collection and reporting of quality of experience (QoE) measurements for a network service;
perform the QoE measurements for the network service based on the set of one or more parameters; and
transmit a second message that comprises the QoE measurements for the network service.

2. The UE of claim 1, wherein the set of one or more parameters includes a time interval for collection of the QoE measurements, a maximum size of a QoE measurement report that includes the QoE measurements, a maximum number of segments of the second message, or a combination thereof.

3. The UE of claim 1, wherein the set of one or more parameters includes a segment parameter associated with a capability of the UE to transmit the second message via multiple segments.

4. The UE of claim 3, wherein the segment parameter identifies a maximum number of segments for the second message.

5. The UE of claim 1, wherein the at least one processor is configured to cause the UE to:
perform, via an application layer of the UE, the QoE measurements for the network service and generate a QoE measurement report container that includes a single QoE measurement report based the one or more parameters;
generate, via an access stratum (AS) layer of the UE, the second message as multiple segments based on the QoE measurement report container and the one or more parameters; and
transmit the multiple segments to a network entity.

6. The UE of claim 5, wherein the one or more parameters include a parameter associated with a maximum number of uplink radio resource control (RRC) segments for the second message.

7. The UE of claim 1, wherein the UE is in an RRC_IDLE state, the at least one processor is further configured to cause the UE to:
receive the first message for a multicast broadcast service (MBS); and
store a QoE measurement report that includes the performed QoE measurements for the network service based in an access stratum (AS) layer buffer of the UE.

8. The UE of claim 1, wherein the network service is a streaming service, a virtual reality service, or a multimedia telephony service for IP multimedia subsystem (IMS) (MTSI) service.

9. A processor for wireless communication, comprising:
at least one controller coupled with at least one memory and configured to cause the processor to:
receive a first message comprising a configuration that indicates a set of one or more parameters associated with collection and reporting of quality of experience (QoE) measurements for a network service;
perform the QoE measurements for the network service based on the set of one or more parameters; and
transmit a second message that comprises the QoE measurements for the network service.

10. The processor of claim 9, wherein the set of one or more parameters includes a time interval for collection of the QoE measurements, a maximum size of a QoE measurement report that includes the QoE measurements, a maximum number of segments of the second message, or a combination thereof.

11. A network entity for wireless communication, comprising:
at least one memory; and
at least one processor coupled with the at least one memory and configured to cause the network entity to:
transmit, to a user equipment (UE), a first message comprising a configuration that indicates a set of one or more parameters associated with collection and reporting of quality of experience (QoE) measurements for a network service; and
receive, from the UE, a second message that comprises the QoE measurements for the network service.

12. The network entity of claim 11, wherein the set of one or more parameters includes a time interval for collection of the QoE measurements, a maximum size of a QoE measurement report that includes the QoE measurements, a maximum number of segments of the second message, or a combination thereof.

13. The network entity of claim 11, wherein the set of one or more parameters includes a segment parameter associated with a capability of the network entity to receive the second message via multiple segments.

14. The network entity of claim 13, wherein the segment parameter identifies a maximum number of segments for the second message.

15. The network entity of claim 14, wherein the segment parameter identifies a maximum number of uplink radio resource control (RRC) segments for the second message.

16. The network entity of claim 11, wherein the set of one or more parameters includes a segment parameter associated with capabilities of one or more neighbor network entities to receive the second message via multiple segments.

17. The network of claim 11, wherein the at least one processor is configured to cause the network entity to
transmit the first message for a multicast broadcast service (MBS).

18. The network entity of claim 11, wherein the network service is a streaming service, a virtual reality service, or a multimedia telephony service for IP multimedia subsystem (IMS) (MTSI) service.

19. A method performed by a network entity, the method comprising:
transmitting, to a user equipment (UE), a first message comprising a configuration that indicates a set of one or more parameters associated with collection and reporting of quality of experience (QoE) measurements for a network service; and
receiving, from the UE, a second message that comprises the QoE measurements for the network service.

20. The method of claim 19, wherein the set of one or more parameters includes a time interval for collection of the QoE measurements, a maximum size of a QoE measurement report that includes the QoE measurements, a maximum number of segments of the second message, or a combination thereof.
